(19) United States
(12) Patent Application Publication
(10) Pub. No.: US 2018/0160838 A1
(43) Pub. Date: Jun. 14, 2018

(54) Shading Composite Film and Producing Method Thereof

(71) Applicant: Jiangsu Hilong Hometextiles Co., Ltd., Yancheng (CN)

(72) Inventors: Limin CHEN, Yancheng (CN); Hongqiao Qiu, Yancheng (CN)

(73) Assignee: Jiangsu Hilong Hometextiles Co., Ltd.

(21) Appl. No.: 15/479,527

(22) Filed: Apr. 5, 2017

(30) Foreign Application Priority Data
Dec. 14, 2016 (CN) 201611158178.4
Dec. 14, 2016 (CN) 201621374377.4

(51) Int. Cl. A47H 23/10; B29C 47/06; B29C 47/14; B32B 27/18; B32B 27/30; B32B 27/32; B29C 47/00; B32B 7/02; B32B 27/08

(52) U.S. Cl. CPC A47H 23/10; B29C 47/065; B29C 47/14; B32B 27/18; B32B 27/306; B29L 2031/719; B29C 47/0004; B29C 47/0021; B32B 7/02; B32B 27/08; B32B 27/32

(57) ABSTRACT

The present disclosure provides a composite film, a producing method of the composite film, a T-die structure for producing such composite film, and the application of the composite film in curtains and composite fabrics. The composite film includes light-reflective resin regions and a light-absorptive resin region, the light-absorptive resin region is located between the light-reflective resin regions such that they are formed into an integrated composite structure. The integrated composite structure is formed by one-time extrusion molding. The composite film of the present disclosure has advantages such as a thin film thickness, high strength and a good shading effect. The fabric and the shading curtain made of the composite film have the characteristics of being highly shading, lightweight and durable, easy to be produced and the like.

### CROSS-REFERENCE TO RELATED APPLICATION

This application claims benefits of Chinese Patent Applications No. 201611158178.4, filed on Dec. 14, 2016, and No. 201621374377.4, filed on Dec. 14, 2016 in the State Intellectual Property Office of China, which are incorporated herein by reference in entirety.

### BACKGROUND

### Technical Field

The present disclosure relates to a shading material and application thereof, and more particularly to a composite film having a full shading property, and applications thereof such as a fabric, a curtain or other curtain-like articles. The present disclosure also relates to a shading composite film, and a producing method and a T-die for producing the same.

### Description of the Related Art

In people's daily life, it is often required to control the brightness of rooms in home environment or in public places such as hotels, offices, conference rooms and the like, to reduce troubles caused to the life and work due to sunlight. And in the bedrooms, theaters, multimedia rooms, dark rooms and other places requiring more strict standards on light, full-shading curtains are particularly required. For shading curtains, not only aesthetics thereof is required, but also a good shading property against sunlight is required as a key indicator.

Most of current full shading fabrics are generally coated, but the coated fabrics are deteriorated in their drapability and air permeability, and the coating is easy to fall off, affecting the shading effect. Also for some curtains, in order to achieve high shading effect, a multi-layer structure or a method of thickening the material are utilized. However, such curtains cannot comply with the simple, lightweight development trend as decorative textiles. To this end, it is pursued in the market to develop a high shading, lightweight and simple shading curtain.

### SUMMARY OF THE INVENTION

It is an object of the present disclosure to overcome insufficiencies in lightness, durability and shading property of materials of conventional coated shading fabrics. It is also an object of the present disclosure to provide a convenient and practical method for producing a shading composite film.

To this end, according to one aspect of the present disclosure, there is provided a composite film comprising light-reflective resin regions and a light-absorptive resin region, wherein the light-absorptive resin region is located between the light-reflective resin regions such that the light-absorptive resin region and the light-reflective resin regions are formed into an integrated composite structure.

Preferably, the integrated composite structure is a composite structure formed by one-time molding a light-reflective resin and a light-absorptive resin.

Preferably, both the light-reflective resin and the light-absorptive resin comprise polymer materials, and the one-time molding comprises extrusion molding.

Preferably, the light-reflective resin comprises a resin containing light-reflective particles.

Preferably, the light-reflective particles comprise at least one of TiO₂, BaSO₄ and SiO₂.

Preferably, the resin comprises at least one of PE, TPU, POE, polyester, polyamide and EVA.

Preferably, the content of the light-reflective particles is in a range from 0.1% to 30% by weight.

Preferably, the light-absorptive resin comprises a resin containing light-absorptive particles.

Preferably, the light-absorptive particles comprise at least one of carbon black, iron black and graphite.

Preferably, the resin comprises at least one of PE, TPU, POE, polyester, polyamide and EVA.

Preferably, the content of the light-absorptive particles is in a range from 0.1% to 30% by weight.

Preferably, the light-reflective resin and/or the light-absorptive resin comprises at least one of a compatilizer and a plasticizer.

Preferably, the compatilizer comprises an oxidized EVA.

Preferably, the oxidized EVA has a molecular weight of 1500 to 15,000.

Preferably, the plasticizer comprises ethylhexyl benzoate.

Preferably, the light-absorptive resin and the light-reflective resins provided on either side of the light-absorptive resin form an integrated composite structure having three regions with a same thickness.

Preferably, the total thickness of the integrated composite structure is in a range from 0.05 mm to 0.5 mm.

According to another aspect of the present disclosure, there is provided a shading fabric comprising the above described composite film.

According to yet another aspect of the present disclosure, there is provided a curtain-like article comprising the above described shading fabric.

According to yet another aspect of the present disclosure there is provided a method of producing a shading composite film, comprising the following steps:

S1: preparing light-reflective particles and light-absorptive particles;

S2: adding the light-reflective particles and the light-absorptive particles into a resin used as a raw material respectively and mixing them with the resin evenly; and

S3, integrally extrusion molding the resin mixed with the light-reflective particles and the resin mixed with the light-absorptive particles.

According to yet another aspect of the present disclosure, there is provided a T-die for integrally extrusion molding a composite film, comprising an output passage and a first input passage, a second input passage and a third input passage communicating with the output passage respectively;

the first input passage, the second input passage and the third input passage are each configured for inputting a resin;

the output passage is configured to integrally extruding the resins to form an integrated composite film.

Preferably, the first input passage directly faces the output passage and is located between the second input passage and the third input passage.

Preferably, the second input passage and the third input passage are located on upper and lower sides of the output passage respectively to be symmetrical with each other.

Preferably, the second input passage and the third input passage are respectively inclined with respect to the output passage at a same angle.

Preferably, said angle is in a range from 10° to 45°.

The shading composite film of the present disclosure has advantages of being durable and lightweight. Fabrics and shading curtains made of the composite film have characteristics of being high shading, lightweight, thin, durable, easy to produce and colorful.

### BRIEF DESCRIPTION OF THE DRAWINGS

FIG. 1 is a structural schematic view of an embodiment of a shading composite film of the present disclosure;

FIG. 2 is a structural schematic view of an embodiment of a T-die for extrusion molding used in the present disclosure;

FIG. 3 is a schematic view illustrating a resin mixed with light-reflective particles and a resin mixed with light-absorptive particles of the present disclosure being coextrusion molded into an integrated composite film; and

FIG. 4 is a structural schematic view of an embodiment of a shading fabric utilizing a shading composite film according to the present disclosure.

### DETAILED DESCRIPTION OF THE PRESENTLY PREFERRED EMBODIMENTS

In order to improve the overall performances of the conventional shading fabric, such as lightness, durability and shading property, and the like, the present disclosure provides a composite film and a producing method thereof. The composite film comprises light-reflective resin regions and a light-absorptive resin region, the light-absorptive resin region is located between the light-reflective resin regions such that the light-absorptive resin region and the light-reflective resin regions are formed into a three-region integrated composite structure through melting. Herein, “integrated” means that the materials of main bodies constituting the film have the same chemical structure, and three functional regions of the film are respectively added with different functional materials and are in a state where they could not be peeled off by melting them such that macromolecular chains are entangled with each other, and the integrated composite structure is formed by a one-time molding process. Preferably, the light-reflective resin and the light-absorptive resin are both polymer materials, whereby a composite film structure in which multiple functional regions are integrated is formed by a one-time melting and extrusion molding process.

In the above described integrally forming process of the film, since the functional film is formed on either side thereof with a region having a light-reflective function, which region contains light-reflective particles, for example, mainly TiO₂, and in the middle thereof with a region having a light-absorptive function, which region contains light-absorptive particles, for example, mainly carbon black. Thus the functional shading film has a good shading performance. The thickness of the integrally formed film structure can be controlled by applying a stretching action to the film, thus is lighter in weight and thinner than the conventional bonded type, coated type shading fabrics. For the structure formed by conventional process such as bonding, coating or the like, on the one hand, the process is more complex, on the other hand, the bonding strength between multiple layers is not high enough, causing the material to peel or fall off.

In addition, for the composite film structure formed by integrating three functional regions of the light-absorptive resin and the light-reflective resin located at either side of the light-absorptive resin, it is preferable in the present disclosure that the thicknesses of the three functional regions are the same, and the total thickness of the integrated composite structure is 0.05 mm to 0.5 mm. Compared to a two-region structure composed of a light-reflective material and a light-absorptive material, the polymer film structure with three integrated functional regions (reflective-absorptive-reflective) ensures that the shading composite film has a white or light-colored visual effect on both front and back sides thereof, while providing a higher shading effect.

The light-reflective resin of the present disclosure is preferably a polymer material containing light-reflective particles, and the light-reflective particles comprise at least one of TiO₂, BaSO₄ and SiO₂. The resin comprises at least one of PE, TPU, POE, polyester, polyamide and EVA. The content of the light-reflective particles is in a range from 0.1% to 30% by weight.

The light-absorptive resin of the present disclosure is preferably a polymer material containing light-absorptive particles. The light-absorptive particles include at least one of carbon black, iron black and graphite. The resin includes at least one of PE, TPU, POE, polyester, polyamide and EVA. The content of the light-absorptive particles is in a range from 0.1% to 30% by weight.

Further, the light-reflective resin and/or the light-absorptive resin contain at least one of a compatilizer and a plasticizer. The compatilizer may comprises an oxidized EVA. The oxidized EVA has a molecular weight of 1500 to 15,000. The plasticizer preferably comprises ethylhexyl benzoate (EHBA).

The composite film of the present disclosure is preferably formed by extrusion molding, or called as plastic extruding. The process specifically comprises the following steps:

In step S1: light-reflective particles and light-absorptive particles are prepared.

In this embodiment, after titanium dioxide powder or high black carbon black powder of a certain particle size being added to an organic ester plasticizer and stirred and mixed, EVA resin after being subject to oxidation and bond breaking, TPU or TPE are added and stirred and mixed, all the materials are added into a twin-screw granulator to be granulated, thus white light-reflective particles and black light-absorptive particles are obtained.

In step S2: the light-reflective particles and the light-absorptive particles are respectively added into a resin used as a raw material and mixed evenly.

In this embodiment, the above described light-reflective particles and light-absorptive particles are respectively added into a resin used as a raw material such as TPU, TPE, PE, EV or the like, and are mixed evenly.

In step S3, the resin mixed with the light-reflective particles and the resin mixed with the light-absorptive particles are integrally coextruded and molded.

In this embodiment, different resins are added to different twin-screw extruders, respectively, and extruded into a composite film integrated with three functions of shading-light absorptive-shading by using a three-input co-extruding T-die.

After the above steps, the thickness of the composite film may be controlled to a desired thickness, for example, 0.05 to 0.5 mm by post-treatment, and then is formed in a roll.

In order to make a better understanding of objects, technical solutions and advantages of the present disclosure, the present disclosure will be further described with reference to the accompanying drawings and exemplary embodiments. It is to be understood that these embodiment are merely illustrative of the disclosure and are not intended to limit the scope of the disclosure. In addition, it is to be understood that various changes and modifications may be made by those skilled in the art after reading the contents of the present disclosure, which are to be considered as being within the scope of the claims appended hereto.

FIG. 1 is a schematic structural view of a shading composite film according to an embodiment of the present disclosure. As shown in FIG. 1, the composite structure of the present disclosure includes a first light-reflective region 2, a light-absorptive region 1 and a second light-reflective region 3. The first light-reflective region 2, the light-absorptive region 1 and the second light-reflective region 3 are all made of resin materials, and are formed by a one-time extrusion molding process. In this embodiment, the three regions are equal in thicknesses to each other and each has a thickness between 0.01 mm and 0.2 mm. However, the present disclosure is not limited to the above described thickness, and the thickness of each region may be adjusted on the basis of the above thickness depending on a desired shading effect and lightweight requirement. For example, the thicknesses of respective regions may be different from each other or the thickness of a certain region may be increased. The different thickness settings should be considered within the scope of protection of the present disclosure.

The first light-reflective region 2 and the second light-reflective region 3 are made of resins containing titanium dioxide powder (with a main component of TiO₂), which resin comprises, for example, TPU, TPE, PE, EVA, or the like, or a combination thereof. In other embodiments, other light-reflective particles may be used instead of the titanium dioxide powder, such as barium sulfate powder, and the like. The light-absorptive region 1 is made of a resin containing carbon black powder, and the material of the resin is similar to that of the light-reflective region. In other embodiments, other light-absorptive particles may be used instead of carbon black powder, such as iron black powder and the like.

An embodiment of the present disclosure provides a method for producing a composite film, comprising following steps:

Step S1: preparing light-reflective particles and light-absorptive particles.

30 parts of titanium dioxide powder having a particle diameter of 0.7 μm are added into 20 parts of an environmentally-friendly organic ester plasticizer and are stirred to be mixed evenly. The mixture then is added with 100 parts by weight of a dried POE resin and stirred, and is added to a twin-screw granulator to be granulated so as to obtain white reflective particles. 25 parts by weight of high black carbon black powder having a particle size of 0.5 μm are added into 46 parts of an environmentally-friendly organic ester plasticizer and are stirred to be mixed evenly, and then added with 100 parts of a dried POE resin, then the mixture is added to a twin-screw granulator to be granulated so as to obtain black light-absorptive particles.

Step S2: adding the light-reflective particles and the light-absorptive particles into a resin used as a raw material to be mixed evenly.

The light-reflective particles and the light-absorptive particles are mixed with a dried EVA resin used as a raw material respectively, the mixing weight ratio of the EVA resin to the light-reflective particles is 100:30, and the mixing weight ratio of the EVA resin to the light-absorptive particles is 100:40.

Step S3: coextruding and molding the resin mixed with the light-reflective particles and the resin mixed with the light-absorptive particles.

On the basis of fully mixing, the mixtures are added to a three-input co-extruder, respectively, such that the resin mixed with the light-reflective particles is guided to upper and lower regions of the extrusion die, and the resin mixed with the light-absorptive particles is guided to a middle region of the extrusion die. The temperatures of the twin-screw extruders are controlled such that a temperature of a first heating region is higher than the melting point of the resin by 25° C., a temperature of a second heating region is higher than the melting point of the resin by 30° C. and a temperature of a third heating region is higher than the melting point of the resin by 40° C., respectively. The temperature of the T-die is controlled to be higher by 25° C. than the melting point of the resin. The film extruded by the T-die is stretched to a thickness of 0.08 mm, and then rolled.

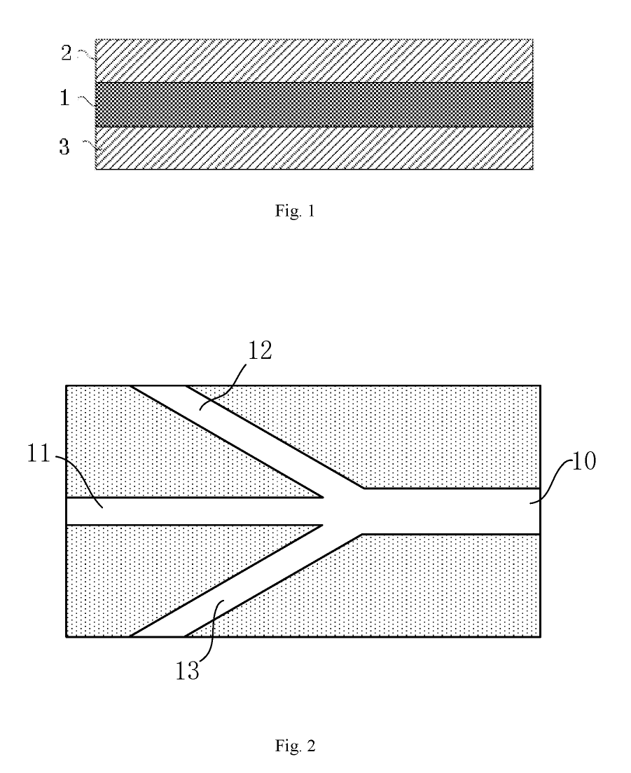

FIG. 2 is a schematic structural view of a T-die for extrusion molding used in the present disclosure. As shown in FIG. 2, the T-die has an output passage 10 and three input passages communicating with the output passage respectively and including a first input passage 11, a second input passage 12 and a third input passage 13. The first input passage 11, the second input passage 12 and the third input passage 13 are all used for introducing a resin. The output passage 10 is used to integrally extrude the resin to form an integrated composite film.

As shown in FIG. 2, the first input passage 11 directly faces the output passage and is located between the second input passage 12 and the third input passage 13. The second input passage 12 and the third input passage 13 are located on upper and lower sides of the output passage 10 respectively and are symmetrical with each other. The second input passage 12 and the third input passage 13 are respectively inclined with respect to the output passage at a same angle, which is preferably 10° to 45°.

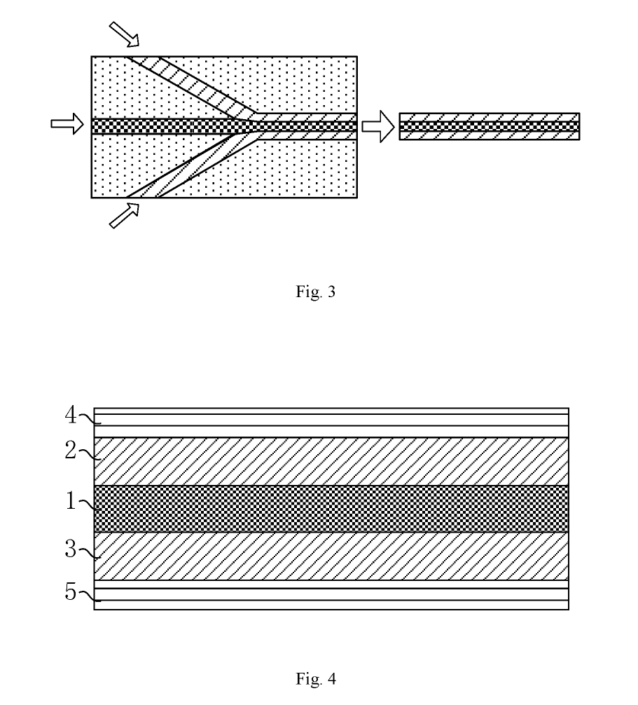

FIG. 3 is a schematic view illustrating the resin mixed with light-reflective particles and the resin mixed with light-absorptive particles are coextruded and molded into an integrated composite film. As show in FIG. 3, the first input passage is used to introduce the resin mixed with light-absorptive particles, and the second input passage and the third input passage are used to introduce the resin mixed with light-reflective particles.

Another embodiment of the present disclosure provides a method for producing a composite film, comprising steps:

Step S1: preparing light-reflective particles and light-absorptive particles.

This step is the same as that of the above embodiment and thus is not described in detail.

Step S2: adding the light-reflective particles and the light-absorptive particles into a resin used as a raw material to be mixed evenly.

The light-reflective particles and the light-absorptive particles are mixed with a dried EVA resin raw material respectively, the mixing weight ratio of the EVA resin to the light-reflective particles is 100:50, and the mixing weight ratio of the EVA resin to the light-absorptive particles is 100:50.

Step S3: coextruding and molding the resin mixed with the light-reflective particles and the resin mixed with the light-absorptive particles.

On the basis of fully mixing, the mixtures are added to a three-input co-extruder, respectively, such that that the resin mixed with light-reflective particles is guided to upper and lower regions of the extrusion die, and the resin mixed with the light-absorptive particles is guided to a middle region of the extrusion die. The extruding temperatures of the twin-screw extruders are controlled such that a temperature of a first heating region is higher than the melting point of the resin by 25° C., a temperature of a second heating region is higher than the melting point of the resin by 30° C. and a temperature of a third heating region is higher than the melting point of the resin by 40° C., respectively. The temperature of the T-die is controlled to be higher by 40° C. than the melting point of the resin. The film extruded by the T-die is stretched to a thickness of 0.09 mm, and then rolled.

A further embodiment of the present disclosure provides a method for producing a composite film, comprising following steps:

Step S1: preparing light-reflective particles and light-absorptive particles.

This step is the same as that of the above embodiments and thus is not described in detail.

Step S2: adding the light-reflective particles and the light-absorptive particles into a resin raw material to be mixed evenly.

The light-reflective particles and the light-absorptive particles are mixed with a dried EVA resin raw material respectively, the mixing weight ratio of the EVA resin to the light-reflective particles is 100:20, and the mixing weight ratio of the EVA resin to the light-absorptive particles is 100:40.

Step S3, coextruding and molding the resin mixed with the light-reflective particles and the resin mixed with the light-absorptive particles.

On the basis of fully mixing, the mixtures are added to different twin-screw extruders, respectively, such that the resin mixed with light-reflective particles is guided to upper and lower regions of an extrusion die, and the resin mixed with the light-absorptive particles is guided to a middle region of the extrusion die. The extruding temperatures of the twin-screw extruders are controlled such that a temperature of a first heating region is higher than the melting point of the resin by 25° C., a temperature of a second heating region is higher than the melting point of the resin by 30° C. and a temperature of a third heating region is higher than the melting point of the resin by 40° C., respectively. The temperature of the T-die is controlled to be higher by 35° C. than the melting point. The film extruded by the T-die is stretched to a thickness of 0.08 mm, and then rolled.

An embodiment in which a shading fabric is produced by using the composite film of the present disclosure will be described below. In this embodiment, a composite textile fabric having a shading function is formed through hot melting the composite film, however, the present disclosure may also adopts other ways to combine a shading composite film with a textile to form a fabric, which should also be regarded as falling within the protection range of the present disclosure.

Combining technology of a film material with textile fabric is the leading technology to achieve the functionalization of textile, and a moisture curing reactive type polyurethane hot melt adhesive becomes the most popular adhesive in the laminating composite industry, with no pollution to the environment. To produce composite textile fabric having a shading function, hot melting composite technology is adopted in this embodiment, which conforms to the direction of environmental protection.

In step T1, the composite film is surface treated.

Firstly, the full shading composite polymer film undergoes a corona surface pretreatment, such that chemical structure of the film surface is modified and the surface tension and the bonding fastness of the shading film are increased.

In step T2, the composite film is combed with textiles.

This embodiment adopts the moisture curing reactive type polyurethane hot melt adhesive, which is molten at 60° C. to 110° C., and is injected into a heat combing machine, which performs one-time combination of a textile with one surface of the full shading composite polymer film. After being cooled and fixed, the other surface of the full shading composite polymer film and a textile are subjected to the same heat combination, such that the full shading composite polymer film is thermally bonded between two layers of textiles. The resultant structure is shown in FIG. 4, and reference numerals 4 and 5 are referred to a first textile layer and a second textile layer, respectively.

On the basis of the above described full shading functional composite textile fabric, conventional tailoring and sewing methods are adopted to produce curtains or shutters with different structures and forms. The full shading curtain obtained by the above technical solutions in the present disclosure achieves its high shading property through combination of the light-reflective/light-absorptive/light-reflective three-region film with the textile.

In view of the above, the shading composite film, and the fabric and the curtains made on basis of the composite film according to the present disclosure at least have the following advantages:

(1) The producing method of the present disclosure is simple, has a low cost and facilitates industrialization;

(2) The resin raw material of the present disclosure has wide sources and is easy to be processed into various shapes and easy to be used; and

(3) The full shading curtain of the present disclosure has a good shading effect and can be applied in the field of interior decoration field such as home, hospital ward, automobile interior decoration and interior decoration of aircraft, and has broad application prospect and market prospect.

The foregoing embodiments give further detailed description of the objects, technical solutions and advantages of the present disclosure. It is to be understood that the foregoing description is only illustrative for the specific embodiments of the disclosure and is not intended to limit the disclosure. Any modifications, equivalent substitutions, improvements, and the like made within the spirit and principles of the present disclosure are intended to be included within the scope of the present invention.

What is claimed is:

1. A composite film comprising light-reflective resin regions and a light-absorptive resin region, wherein the light-absorptive resin region is located between the light-reflective resin regions such that the light-absorptive resin region and the light-reflective resin regions are formed into an integrated composite structure.

2. The composite film according to claim 1, wherein the integrated composite structure is a composite structure formed by one-time molding a light-reflective resin and a light-absorptive resin.

3. The composite film according to claim 2, wherein both the light-reflective resin and the light-absorptive resin comprise polymer materials, and the one-time molding comprises extrusion molding.

4. The composite film according to claim 3, wherein the light-reflective resin comprises a resin containing light-reflective particles, and/or the light-absorptive resin comprises a resin containing light-absorptive particles.

5. The composite film according to claim 4, wherein the light-reflective particles comprise at least one of TiO₂, BaSO₄ and SiO₂, and/or the light-absorptive particles comprise at least one of carbon black, iron black and graphite.

6. The composite film according to claim 4, wherein the light-reflective resin and/or the light-absorptive resin comprises at least one of PE, TPU, POE, polyester, polyamide and EVA.

7. The composite film according to claim 4, wherein the content of the light-reflective particles is in a range from 0.1% to 30% by weight, and/or the content of the light-absorptive particles is in a range from 0.1% to 30% by weight.

8. The composite film according to claim 3, wherein the light-reflective resin and/or the light-absorptive resin comprises at least one of a compatilizer and a plasticizer.

9. The composite film according to claim 8, wherein the compatilizer comprises an oxidized EVA.

10. The composite film according to claim 9, wherein the oxidized EVA has a molecular weight of 1,500 to 15,000.

11. The composite film according to claim 8, wherein the plasticizer comprises ethylhexyl benzoate.

12. The composite film according to claim 3, wherein the integrated composite structure is formed by the light-absorptive resin and the light-reflective resins provided respectively on two sides of the light-absorptive resin such that the integrated composite structure has three regions which have the same thickness.

13. A shading fabric comprising the composite film according to claim 1.

14. A curtain-like article comprising the shading fabric according to claim 13.

15. A method of producing a shading composite film, comprising the following steps:
S1: preparing light-reflective particles and light-absorptive particles;
S2: adding the light-reflective particles and the light-absorptive particles into a resin used as a raw material respectively and mixing them with the resin evenly; and
S3, integrally extrusion molding the resin mixed with the light-reflective particles and the resin mixed with the light-absorptive particles.

16. A T-die for integrally extrusion molding a composite film, the T-die comprising an output passage and a first input passage, a second input passage and a third input passage communicating with the output passage respectively;
wherein the first input passage, the second input passage and the third input passage are each configured for inputting a resin; and
the output passage is configured to integrally extrude the resins to form an integrated composite film.

17. The T-die according to claim 16, wherein the first input passage directly faces the output passage and is located between the second input passage and the third input passage.

18. A T-die according to claim 17, wherein the second input passage and the third input passage are located on upper and lower sides of the output passage respectively to be symmetrical with each other.

19. The T-die according to claim 18, wherein the second input passage and the third input passage are respectively inclined with respect to the output passage at the same angle.

20. The T-die according to claim 19, wherein said angle is in a range from 10° to 45°.
